(19) United States
(12) Patent Application Publication
(10) Pub. No.: US 2019/0075926 A1
(43) Pub. Date: Mar. 14, 2019

(54) OVERTURN PREVENTING DEVICE AND METHOD OF MOUNTING THE SAME

(71) Applicant: KYB CORPORATION, Minato-ku, Tokyo (JP)

(72) Inventors: Shinichi SEKINE, Minato-ku, Tokyo (JP); Akihisa OOTA, Minato-ku, Tokyo (JP); Masaya UNE, Minato-ku, Tokyo (JP); Atsushi TOYOUCHI, Minato-ku, Tokyo (JP); Yukiko ISHIHARA, Minato-ku, Tokyo (JP); Chika IIDA, Minato-ku, Tokyo (JP)

(73) Assignee: KYB CORPORATION, Minato-ku, Tokyo (JP)

(21) Appl. No.: 16/085,307

(22) PCT Filed: Feb. 20, 2017
(86) PCT No.: PCT/JP2017/006210

§ 371 Date: Sep. 14, 2018

(30) Foreign Application Priority Data
Mar. 24, 2016 (JP) 2016-059654

(51) Int. Cl. A47B 95/00; A47B 97/00; F16F 15/023; F16F 15/04; F16F 9/19

(52) U.S. Cl. CPC A47B 95/00; A47B 97/00; A47B 2097/008; F16F 15/04; F16F 9/19; F16F 15/023

(57) ABSTRACT

Providing an overturn preventing device which can be easily mounted between a top surface of a piece of furniture and a ceiling and a method of mounting the overturn preventing device. The overturn preventing device includes a damper and a pair of bases. The damper has a cylinder and a piston slidably housed in the cylinder. The damper is mounted between a top surface of a piece of furniture (article) installed on an installation surface and a ceiling. The paired bases are respectively coupled to two ends of the damper. One of the bases abuts against the top surface of the furniture and the other base abuts against the ceiling. The cylinder has an inlet through which a hydraulic fluid (operating liquid) is poured into the cylinder.

### TECHNICAL FIELD

The present invention relates to an overturn preventing device and a method of mounting the same.

### BACKGROUND ART

Patent Document 1 discloses a conventional overturn preventing device. This overturn preventing device includes a damper and a pair of bases. The damper is mounted between a top surface of a piece of furniture installed on a floor surface and a ceiling. The damper has two ends respectively supported by the paired bases to be rotatable about rotation axes. One of the bases abuts against the top surface of the furniture and the other base abuts against the ceiling. Accordingly, when the furniture is tilted by shaking of an earthquake or the like in a direction parallel to a rotation direction of the damper, the damper is rotated about the rotation axes relative to the bases with the result that the bases can be maintained in abutment against the top surface of the furniture and the ceiling respectively. Consequently, this overturn preventing device can apply a damping force of the damper to the furniture thereby to suppress the tilt of the furniture and prevent the furniture from overturn.

### PRIOR ART DOCUMENT

### Patent Documents

Patent Document 1: Japanese Patent Application Publication No. JP 2015-6330

### SUMMARY OF THE INVENTION

### Problem to Be Overcome by the Invention

However, when the overturn preventing device of Patent Document 1 is to be mounted between the top surface of the furniture and the ceiling, it is necessary to cause the paired bases to abut against the top surface of the furniture and the ceiling respectively while contracting the damper against an expansion force of compressed gas acting in an extension direction of the damper so that the damper assumes a desired mounting posture (for example, a posture in which the damper assumes a desired inclination angle). It is difficult for the worker to thus mount the overturn preventing device into a desired posture while contracting the damper above the furniture.

The present invention was made in view of the above-described circumstances in the conventional art and has an object to provide an overturn preventing device which can be easily mounted between the top surface of the furniture and the ceiling.

### Means for Overcoming the Problem

An overturn preventing device of the present invention includes a damper and a pair of bases. The damper includes a cylinder having an end with an opening, a piston slidably housed in the cylinder, a rod having a distal end side protruding out of the cylinder and a proximal end coupled to the piston and a rod guide into which the rod is slidably inserted. The rod guide closes the opening of the cylinder. The damper is mounted between a top surface of an article installed on an installation surface and a ceiling. The paired bases are respectively coupled to two ends of the damper. One of the bases abuts against the top surface of the article and the other of the bases abuts against the ceiling. The damper has an inlet through which an operating liquid is poured into the cylinder.

In the overturn preventing device in accordance with the invention, the damper may have a biasing part imparting a biasing force which biases the rod in such a direction that the rod protrudes out of the cylinder.

In the overturn preventing device in accordance with the invention, the rod may be formed with a mark indicative of an amount of protrusion out of the cylinder according to the amount of protrusion.

In the overturn preventing device in accordance with the invention, the cylinder may include at least a part thereof formed to be transparent.

In the overturn preventing device in accordance with the invention, the inlet may be formed at a location near the opening side end of the cylinder.

In the overturn preventing device in accordance with the invention, the inlet may be formed in the rod guide.

A method of mounting the overturn preventing device in accordance with the invention includes a step of causing the paired bases to abut against the top surface of the article and the ceiling respectively, and a step of pouring the operating liquid through the inlet into the cylinder.

Here, the article includes a piece of furniture, a bed having a plurality of beds connected to each other in the up-down direction, a large sized television, a refrigerator, a book shelf, a showcase, a server rack, and the like all of which have a possibility of being overturned by the shaking of an earthquake or the like. The installation surface includes not only the floor surface in the building, but also a foundation surface and the like on which the article is placed outside the building.

### BRIEF DESCRIPTION OF THE DRAWINGS

FIG. 1 is a schematic diagram of the overturn preventing device of a first embodiment;

FIG. 2 is a schematic front view of the overturn preventing device of the first embodiment, mounted between a top surface of the furniture and a ceiling;

FIG. 3 is a partial cross section of a damper and a first base of the overturn preventing device of the first embodiment;

FIG. 4 is a schematic diagram for explaining a method of mounting the overturn preventing device of the first embodiment;

FIG. 5 is a schematic diagram of the overturn preventing device of a second embodiment;

FIG. 6 is a schematic diagram of the overturn preventing device of a third embodiment; and

FIG. 7 is a schematic enlarged cross section of a major part of the overturn preventing device of a fourth embodiment.

### BEST MODE FOR CARRYING OUT THE INVENTION

First to fourth embodiments of the overturn preventing device and the method of mounting the same, in accordance with the present invention will be described with reference to the drawings.

### First Embodiment

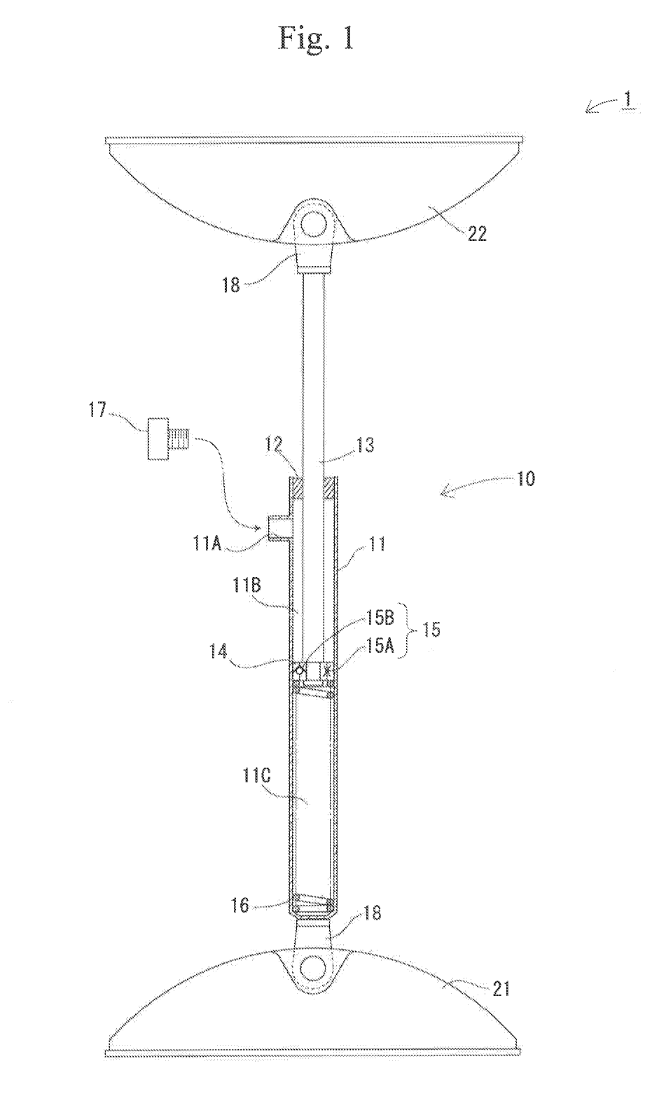

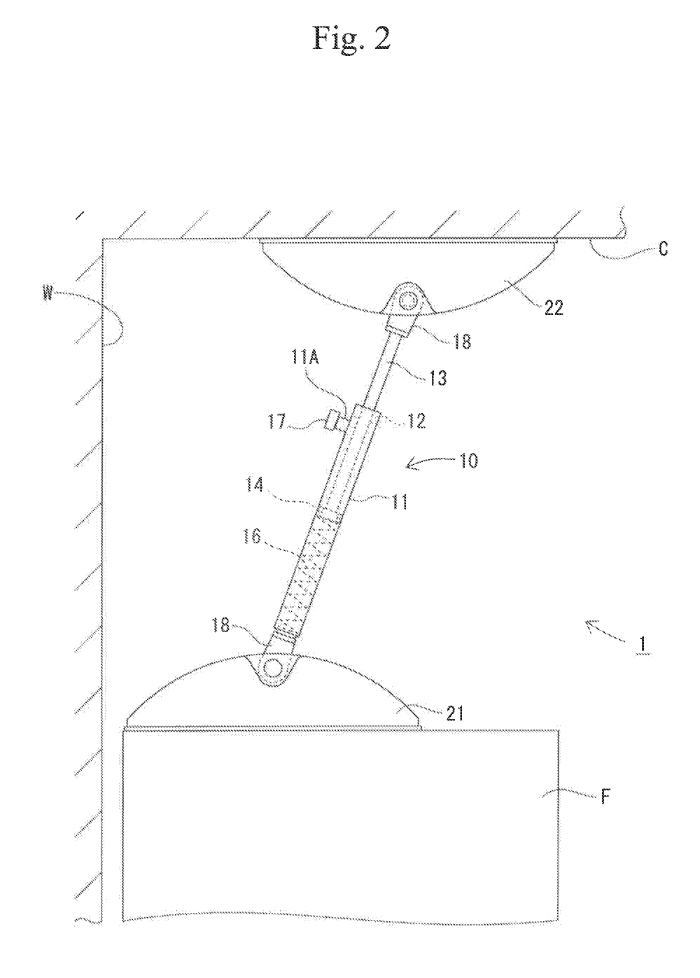

The overturn preventing device 1 of the first embodiment includes a damper 10 and a pair of bases 21 and 22 as illustrated in FIGS. 1 and 2. The damper 10 is mounted between a top surface of a piece of furniture F (exemplified as an article in the invention) and a ceiling C. The damper has two ends to which the paired bases 21 and 22 are respectively coupled. One of the bases 21 abuts against the top surface of the furniture F and the other base 22 abuts against the ceiling C.

At least one overturn preventing device 1 of the first embodiment is mounted between the top surface of the furniture F and the ceiling C, as illustrated in FIG. 2. The overturn preventing device 1 prevents overturn of the furniture F using a damping force of the damper 10 when the furniture F is tilted due to the occurrence of shaking of an earthquake or the like. The furniture F is installed on a floor surface (not illustrated) serving as an installation surface while a rear surface of the furniture F is opposed to a wall surface W extending in a vertical direction from the floor surface. The furniture F is formed into a rectangular parallelepiped shape and has a door, a drawer (neither illustrated) and the like in a front surface (a right side as viewed in FIG. 1), so that clothes, accessories and the like can be housed in the furniture F. The furniture F has a rectangle-shaped horizontal section long in a right-left direction (a depthwise direction in FIG. 1). When the overturn preventing device is not mounted on the furniture F, the furniture F would possibly be tilted frontward (rightward in FIG. 1) by shaking of an earthquake or the like thereby to be overturned.

The damper 10 has a cylinder 11, a rod guide 12, a rod 13, a piston 14, a damping part 15 and a compression coil spring 16 (exemplified as a biasing part in the invention). The cylinder 11 is formed into a bottomed cylindrical shape. The rod guide 12 closes an opening of the cylinder 11. The rod 13 is slidably inserted through the rod guide 12, so that a distal end thereof protrudes out of the cylinder 11. The rod 13 has a distal end connected to the piston 14. The piston 14 is slidably housed in the cylinder 11 so as to divide an interior of the cylinder 11 into a rod side pressure chamber 11B in which a distal end of the rod 13 is housed and a counter-rod side pressure chamber 11C.

The damping part 15 imparts resistance to a flow of fluid moving from the counter-rod side pressure chamber 11C to the rod side pressure chamber 11B. The damping part 15 has an orifice 15A and a check valve 15B. The orifice 15A and the check valve 15B are each provided in a flow passage communicating between the rod side pressure chamber 11B and the counter-rod side pressure chamber 11C. The orifice 15A imparts resistance to the flow of the fluid in both directions. The check valve 15B allows the fluid to flow from the rod side pressure chamber 11B to the counter-rod side pressure chamber 11C, and blocks the reverse flow. The orifice 15A and the check valve 15B are provided in the piston 14.

The compression coil spring 16 imparts a biasing force to the rod 13 so that the rod 13 protrudes out of the cylinder 11. The compression coil spring 16 has two ends one of which is in abutment against a bottom inner surface of the cylinder 11 and the other of which is in abutment against the piston 14, so that the piston 14 is biased in such a direction that the counter-rod side pressure chamber 11C is enlarged.

The damper 10 is a compression damper in which a damping force generated during an extending operation is smaller than a damping force generated during a contracting operation. The extending operation of the damper 10 refers to an operation which increases an amount of protrusion of the rod 13 out of the cylinder 11 and the length of the damper 10. The contracting operation of the damper 10 refers to an operation which reduces an amount of protrusion of the rod 13 out of the cylinder 11 and the length of the damper 10.

The following will describe a mechanism of generating a damping force of the damper 10 by the damping part 15. The orifice 15A imparts resistance to the flow of hydraulic fluid between the rod side pressure chamber 11B and the counter-rod side pressure chamber 11C with both extending and contracting operation of the damper 10. The check valve 15B allows the fluid to flow from the rod side pressure chamber 11B to the counter-rod side pressure chamber 11C and blocks the reverse flow. Accordingly, the damper 10 has two flow paths of the hydraulic fluid from the rod side pressure chamber 11B to the counter-rod side pressure chamber 11C during the extending operation, that is, one flow path including the orifice 15A and the other flow path including the check valve 15B. On the other hand, the damper 10 has only one flow path of the hydraulic fluid from the counter-rod side pressure chamber 11C to the rod side pressure chamber 11B through the orifice 15A during the contracting operation. Accordingly, the damping force generated by the damper 10 during the extending operation is smaller than the damping force generated by the damper 10 during the contracting operation.

The paired bases 21 and 22 are the first base 21 coupled to a bottom of the cylinder 11 and the second base 22 coupled to a distal end of the rod 13. The first base 21 abuts against the top surface of the furniture F, and the second base 22 abuts against the ceiling C. The first and second bases 21 and 22 are rotatable relative to the damper 10. The first and second bases 21 and 22 have substantially the same form and the same structure.

The damper 10 has an inlet 11A through which a hydraulic fluid (exemplified as an operating liquid in the invention) is poured into the cylinder 11. The inlet 11A is formed in the cylinder 11 to communicate between an interior space and an exterior space of the cylinder 11. A screw cap 17 threadingly engageable with a female screw (not illustrated) formed on an inner wall of the inlet 11A is attached to the inlet 11A. The screw cap 17 is capable of closing an opening of the inlet 11A in a gas-tight and liquid-tight manner.

In this embodiment, the inlet 11A is formed near an end at the opening side (the rod guide 12 side) of the cylinder 11. As illustrated in FIG. 2, the damper 10 is mounted in such a direction that the rod 13 protrudes upward out of the cylinder 11. Accordingly, it can be said that the inlet 11A is formed near the upper end of the cylinder 11 at the time of the mounting of the damper 10.

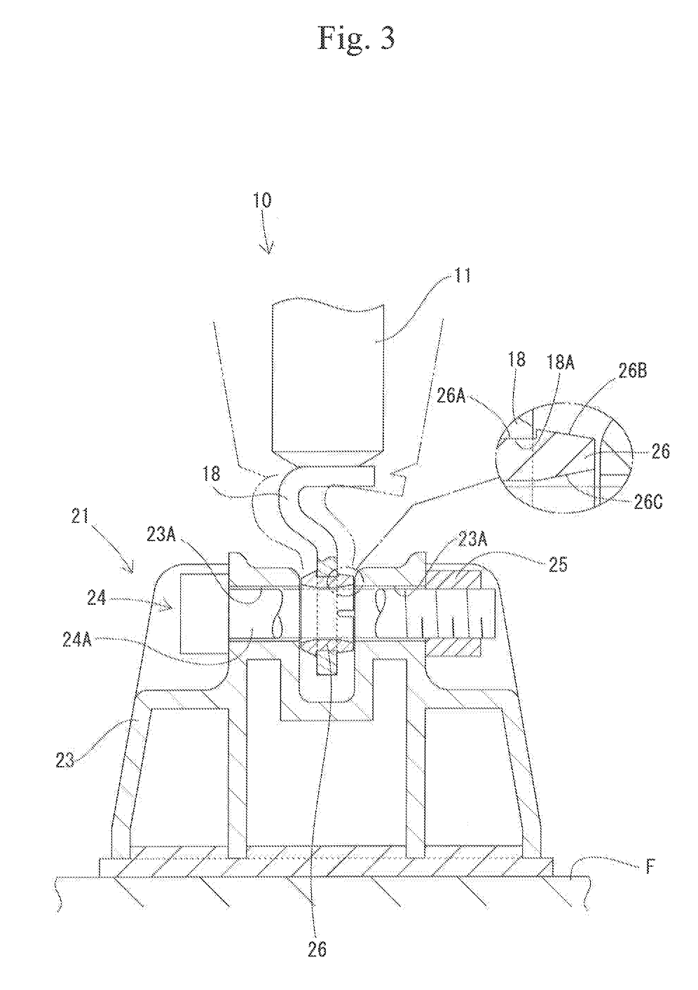

Furthermore, the damper 10 has two joints 18 respectively provided on both ends thereof. Each joint 18 is formed by bending a flat plate-shaped metal fitting as illustrated in FIG. 3. The joints 18 are respectively connected to a bottom of the cylinder 11 and the distal end of the rod 13. Each joint 18 is formed with a through hole 18A extending therethrough in a direction perpendicular to an axis line of the damper 10.

The first and second bases 21 and 22 each have a base body 23, a bolt 24 and a nut 25 serving as a rotating shaft member, and a bush 26. Since the first and second bases 21 and 22 have substantially the same form and the same structure as described above, the first base 21 will be described in the following.

The base body 23 is hollow as illustrated in FIG. 3 and has an insertion hole 23A. The rotating shaft member is inserted through the insertion hole 23A. The rotating shaft member is constituted of the bolt 24 inserted from one side of the insertion hole 23A and the nut 25 screwed onto a shaft part 24A of the bolt 24. The bolt 24 has a central axis which serves as a rotation axis of the damper 10 in each of the bases 21 and 22.

The bush 26 is substantially cylindrical in shape as illustrated in FIG. 3 and is elastic. The bush 26 has a length that is set in such a manner that slight gaps are respectively defined between both end surfaces thereof and the base body 23 when attached to the base body 23. The bush 26 is formed with a concave portion 26A going around a central part of the outer peripheral surface thereof. The concave portion 26A has an outer diameter that substantially equals an inner diameter of the through hole 18A formed through the joint 18 of the damper 10. The bush 26 has portions rising from both ends of the concave portion 26A which portions have outer diameters larger than the inner diameter of the through hole 18A of the joint 18. Furthermore, both ends of the bush 26 have respective outer peripheral surfaces 26B the diameters of which are outwardly reduced. As a result, the bush 26 is inserted into the through hole 18A of the joint 18 of the damper 10 while being elastically deformed. The concave portion 26A is then fitted to the through hole 18A so that the bush 26 is attached to the joint 18 of the damper 10.

The central part of the bush 26 has an inner diameter slightly larger than an outer diameter of the shaft part 24A of the bolt 24. Furthermore, both ends of the bush 26 have inner peripheral surfaces 26C the diameters of which are outwardly enlarged. Accordingly, the bush 26 is rotatable about the shaft part 24A of the bolt 24. Furthermore, the bush 26 is inclinable with respect to the shaft part 24A of the bolt 24 to the extent that the inner peripheral surfaces 26C of both ends thereof having enlarged diameters abut against an outer peripheral surface of the shaft part 24A of the bolt 24. In other words, the damper 10 with the bush 26 attached to the joint 18 is rotatable about the shaft part 24B of the bolt 24 and swingable in a direction intersecting the rotation direction. Furthermore, the damper 10 can be swung more largely in the direction intersecting the rotation direction by the elastic deformation of the bush 26.

When the overturn preventing device 1 is to be mounted between the top surface of the furniture F and the ceiling C, no hydraulic fluid has been poured into the cylinder 11. In other words, air is enclosed in the cylinder 11 in the initial state of the overturn preventing device 1 before the mounting. As a result, the piston 14 is not immersed in the hydraulic fluid but is in air. In this embodiment, air in the cylinder 11 is at an atmospheric pressure. The air in the cylinder 11 may be pressurized or depressurized, but when the screw cap 17 is removed, an atmospheric pressure is recovered.

The overturn preventing device 1 having the above-described construction will be mounted between the top surface of the furniture F and the ceiling C in the following manner.

First, the overturn preventing device 1 is mounted between the furniture F and the ceiling C. More specifically, the first base 21 is placed in abutment on the top surface of the furniture F, and the second base 22 is caused to abut against the ceiling C. In this case, the locations of the bases 21 and 22 are adjusted while the damper 10 is being suitably contracted so that an inclination angle of the damper 10 with respect to the vertical direction becomes between 150 and 25° and so that a rotation direction of the damper 10 relative to the bases 21 and 22 is substantially parallel to the direction in which the furniture F is tilted. No hydraulic fluid has been poured into the cylinder 11 during this adjustment. Accordingly, the damper 10 can be contracted by a smaller load than that in the case where the hydraulic fluid has been poured into the cylinder 11. As a result, the angle adjustment of the damper 10 and the location adjustment of the bases 21 and 22 can be easily carried out. Furthermore, after the mounting of the overturn preventing device 1, the biasing force of the compression coil spring 16 causes the rod 13 to protrude and the damper 10 extends, so that a stretching force acts between the top surface of the furniture F and the ceiling C. As a result, the adjusted angle of the damper 10 and the locations of the bases 21 and 22 can be suitably maintained.

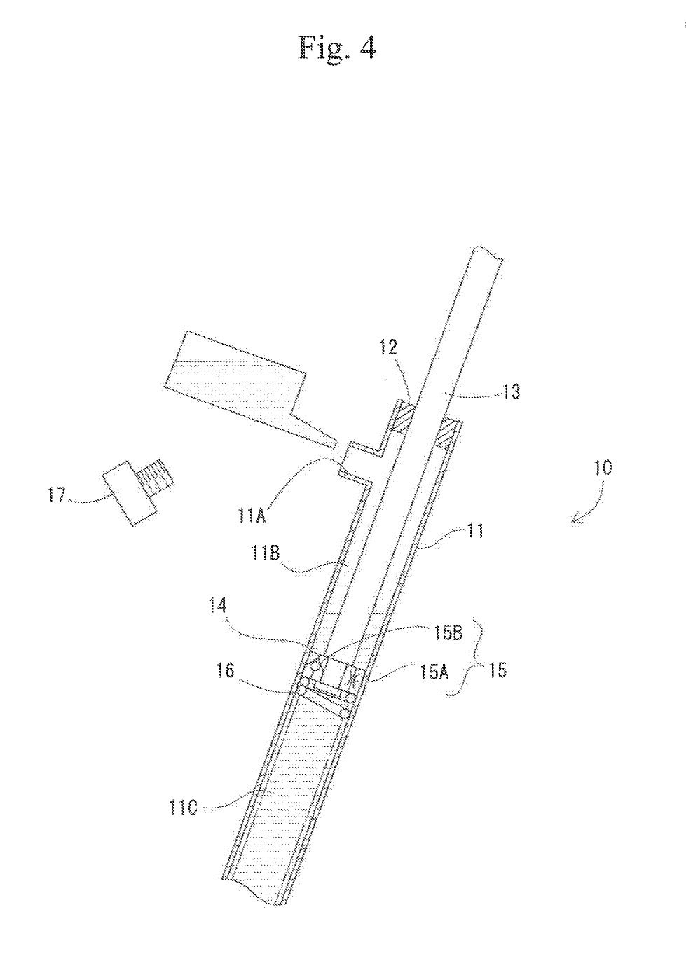

Upon completion of the mounting, the hydraulic fluid is poured through the inlet 11A into the cylinder 11 as illustrated in FIG. 4. An amount of the hydraulic fluid to be poured is the amount with which the entire piston 14 in the cylinder 11 can be immersed in the hydraulic fluid. As a result, when the furniture F tilts and a force contracting the damper 10 works, the hydraulic fluid passes through the damping part 15 with movement of the piston 14, so that a damping force is generated. Upon completion of the pouring of the hydraulic fluid, the screw cap 17 is lastly screwed into the inlet 11A.

As described above, the overturn preventing device 1 of the first embodiment includes the damper 10 and the paired bases 21 and 22. The damper 10 has the cylinder 11 and the piston 14 slidably housed in the cylinder 11. The damper 10 is mounted between the top surface of the furniture F installed on the installation surface and the ceiling C. The paired bases 21 and 22 are respectively coupled to both ends of the damper 10. The base 21 abuts against the top surface of the furniture F, and the base 22 abuts against the ceiling C. The damper 10 has the inlet 11A through which the hydraulic fluid is poured into the cylinder 11.

The hydraulic fluid can be poured into the overturn preventing device 1 after the overturn preventing device 1 has been mounted to a desired mounting location. In other words, the overturn preventing device 1 can be installed in a state where no hydraulic fluid is contained (air is contained) in the cylinder 11. Accordingly, it is possible to slide the piston 14 in the cylinder 11 by a smaller load than that in the case where the hydraulic fluid has been poured in the overturn preventing device 1. As a result, the length of the device 1 can be easily adjusted.

Accordingly, the overturn preventing device 1 of the first embodiment can be easily mounted between the top surface of the furniture F and the ceiling C by the above-described mounting method.

Furthermore, the overturn preventing device 1 has the compression coil spring 16 serving as the biasing part. The compression coil spring 16 imparts the biasing force that biases the rod 13 in the protruding direction from the cylinder 11. As a result, it is possible to constantly apply the biasing force to cause the rod 13 to protrude, so that the bases 21 and 22 can be maintained in abutment against the furniture F and the ceiling C respectively even when the inlet 11A is open at the time of the mounting.

Furthermore, the inlet 11A is formed at the location near the opening side end (the rod guide 12 side) of the cylinder 11, more specifically, at the location near the upper end of the cylinder 11 at the time of the mounting. Accordingly, the hydraulic fluid can be poured up to a higher location in the cylinder 11. As a result, an allowable range of the location of the piston 14 at the time of the mounting can be rendered large, and a range of the distance between the furniture F and the ceiling C capable of mounting the overturn preventing device 1 can be rendered large. In other words, an applicable range of the overturn preventing device can be increased.

Furthermore, since the hydraulic fluid can be poured into the cylinder 11 after the mounting of the overturn preventing device 1, an amount of hydraulic fluid to be poured can be adjusted according to the location of the piston 14 after the mounting. For example, when the location of the piston 14 at the time of the mounting is near a lower end of the cylinder 11, an amount of hydraulic fluid to be poured can be reduced. Thus, a minimum necessary amount of hydraulic fluid can be poured according to the location of the piston 14 at the time of the mounting.

When the overturn preventing device 1 is to be demounted from between the furniture F and the ceiling C or the location is to be re-adjusted after the mounting, the work can be easily carried out by draining the hydraulic fluid from the inlet 11A so that the piston 14 is not immersed in the hydraulic fluid.

### Second Embodiment

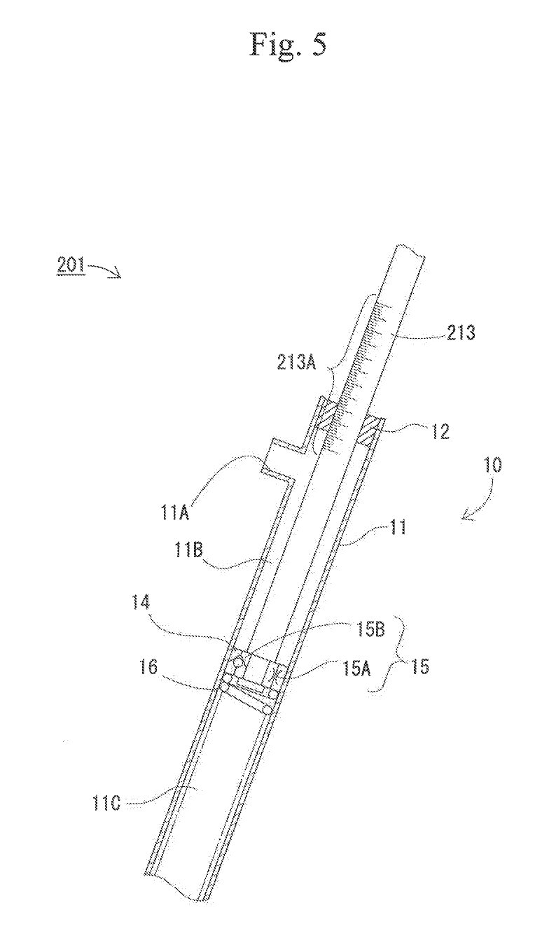

Next, a second embodiment will be described with reference to FIG. 5 and the like.

The overturn preventing device 201 of the second embodiment as illustrated in FIG. 5 and the like differs from the overturn preventing device 1 of the first embodiment in that the rod 213 is formed with a scale 213A (exemplified as a mark in the invention). The overturn preventing device 201 has the same construction and functions as the overturn preventing device 1 of the first embodiment in the other respects. Therefore, the parts other than the rod 213 are labeled by the same reference symbols as those in the first embodiment, and the detailed description of these parts will be eliminated. Furthermore, the furniture F installed on the installation surface is also exemplified as the article in the following description. However, the overturn preventing device 201 may be applied to any article other than the furniture.

The rod 213 is formed with the scale 213A as illustrated in FIG. 5. The scale 213A is formed along an axial direction of the rod 213 on an outer surface of the rod 213. The scale 213A is a mark indicative of an amount of protrusion of the rod 213 out of the cylinder 11 according to the amount of protrusion.

The overturn preventing device 201 of the second embodiment constructed as described above is mounted in the same manner as the overturn preventing device 1 of the first embodiment. First, the first base 21 is placed in abutment on the top surface of the furniture F, and the second base 22 is caused to abut against the ceiling C, so that the overturn preventing 201 is mounted between the furniture F and the ceiling C. The hydraulic fluid is then poured through the inlet 11A into the cylinder 11. An amount of the hydraulic fluid to be poured is the amount with which the entire piston 14 is immersed in the hydraulic fluid, as in the first embodiment. In this case, an amount of protrusion of the rod 213 out of the cylinder 11 can be understood from the scale 213A of the rod 213. Furthermore, since the piston 14 is coupled to the proximal end of the rod 213, the location of the piston 14 in the cylinder 11 can be understood based on the amount of protrusion of the rod 213. As a result, an adequate amount of hydraulic fluid can be poured.

As described above, the overturn preventing device 201 of the second embodiment can be easily mounted between the top surface of the furniture F and the ceiling C by the above-described mounting method, and in addition, an adequate amount of hydraulic fluid can be reliably poured.

### Third Embodiment

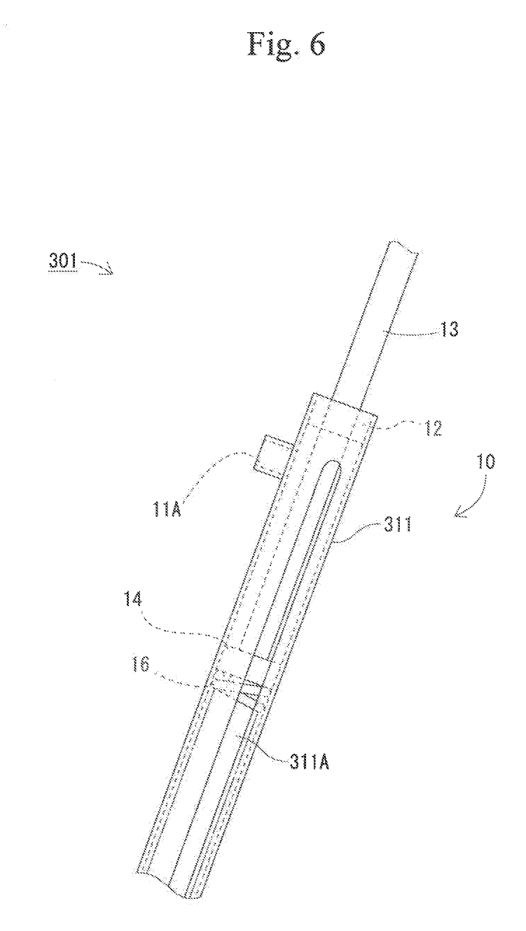

Next, a third embodiment will be described with reference to FIG. 6 and the like. The overturn preventing device 301 of the third embodiment as illustrated in FIG. 6 differs from the overturn preventing device 1 of the first embodiment in that at least a part of the cylinder 311 is formed to be transparent. The cylinder 311 in the third embodiment has a window 311A formed along the axial direction of the cylinder 311. The window 311A is formed to be transparent, so that the interior of the cylinder 311 is visible through the window 311A. The overturn preventing device 301 has the same construction and functions as the overturn preventing device 1 of the first embodiment in the other respects. Therefore, the parts other than the cylinder 311 are labeled by the same reference symbols as those in the first embodiment, and the detailed description of these parts will be eliminated. Furthermore, the furniture F installed on the installation surface is also exemplified as the article in the following description. However, the overturn preventing device 301 may be applied to any article other than the furniture.

The overturn preventing device 301 of the third embodiment constructed as described above is also mounted in the same manner as the overturn preventing device 1 of the first embodiment. First, the first base 21 is placed in abutment on the top surface of the furniture F, and the second base 22 is caused to abut against the ceiling C, so that the overturn preventing 301 is mounted between the furniture F and the ceiling C. The hydraulic fluid is then poured through the inlet 11A into the cylinder 311. In this case, since the cylinder 311 is formed with the window 311A, the location of the piston 14 in the cylinder 311 is visible. Furthermore, an fluid level of the poured hydraulic fluid is also visible. As a result, an adequate amount of hydraulic fluid can be poured.

As described above, the overturn preventing device 301 of the third embodiment can be easily mounted between the top surface of the furniture F and the ceiling C by the above-described mounting method, and in addition, an adequate amount of hydraulic fluid can be reliably poured.

### Fourth Embodiment

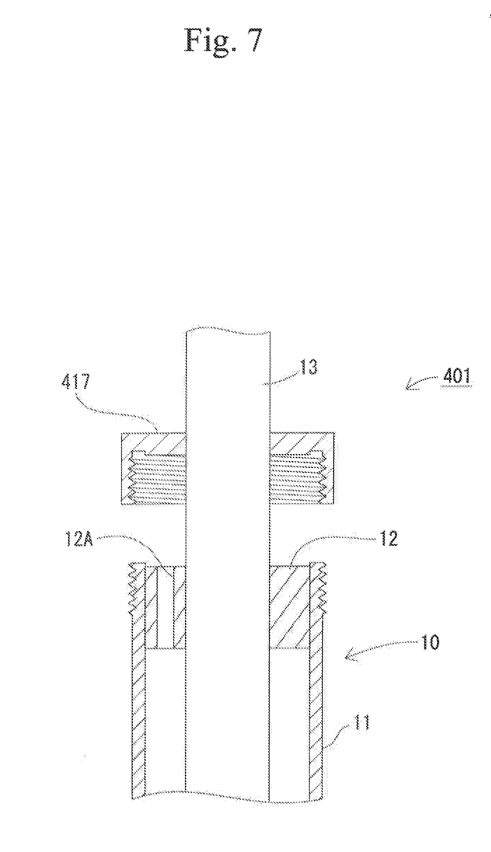

Next, a fourth embodiment will be described with reference to FIG. 7 and the like. The overturn preventing device of the fourth embodiment as illustrated in FIG. 7 differs from the overturn preventing device 1 of the first embodiment in that the inlet 12A is formed in the rod guide 12. Accordingly, the parts other than the inlet 12A are labeled by the same reference symbols as those in the first embodiment, and the detailed description of these parts will be eliminated. The inlet 12A is closed by the screw cap 417 screwed to the opening end side of the cylinder 11.

The overturn preventing device 401 of the fourth embodiment constructed as described above is also mounted in the same manner as the overturn preventing device 1 of the first embodiment. When being poured through the inlet 12A into the cylinder 11, the hydraulic fluid can be poured up to near the upper end of the cylinder 11 since the inlet 12A is formed in the rod guide 12 closing the opening of the cylinder 11 located at the upper end side at the time of the mounting. As a result, an allowable range of the location of the piston 14 at the time of the mounting can be rendered large, and a range of the distance between the furniture F and the ceiling C capable of mounting the overturn preventing device 401 can be rendered large. In other words, an applicable range of the overturn preventing device can be increased. Furthermore, the inlet can be formed more easily in the fourth embodiment as compared with the first to third embodiments in each of which the inlet is formed in the outer peripheral surface of the cylinder.

The present invention should not be limited to the embodiments described above with reference to the drawings, but the technical scope of the invention encompasses the following embodiments, for example.
(1) Although the overturn preventing device is mounted on the furniture in the foregoing first to fourth embodiments, the overturn preventing device may be mounted on another article, for example, a bed having a plurality of beds connected to each other in the up-down direction, a large sized television, a refrigerator, a book shelf, a showcase, or a server rack, all of which has a possibility of being overturned by shaking of an earthquake or the like.
(2) Although the overturn preventing device is mounted on the furniture installed on the floor surface with its rear surface being opposed to the wall surface in the first to fourth embodiments, the overturn preventing device may be mounted on the furniture or the like installed on the floor surface without being adjacent to the wall surface.
(3) Although the compression damper is used in the first to fourth embodiments, a two-way damper or an extension damper may be used. When using these dampers, attention should be paid to the location and the number of the bases to be fixed to the article or the ceiling, an inclination angle and the inclination direction of the damper, and the like, so that the device should be mounted appropriately according to the type of the damper.
(4) In each of the first to fourth embodiments, the compression coil spring is used as the biasing part imparting a biasing force which causes the damper to extend. However, the biasing force may be imparted by another method. For example, a compressed gas may be used. In this case, the compressed gas can be put into the cylinder through the inlet after the mounting of the device as well as the operating liquid.
(5) Although the scale indicative of the amount of protrusion of the rod out of the cylinder according to the amount of protrusion is exemplified as a mark in the second embodiment, the mark should not be limited to this. For example, a mark may be indicative of a location of the piston in the cylinder, a necessary amount of operating liquid to be poured or the like.
(6) Although the single window is provided as the example of at least a part of the cylinder formed to be transparent in the third embodiment. However, for example, a plurality of windows may be provided. In this case, the windows can be arranged in parallel in a circumferential direction and/or in an axial direction.
(7) The configuration in which the mark as in the second embodiment is provided and the configuration in which a part of the cylinder is formed to be transparent as in the third embodiment may be combined together. In this case, an amount of operating liquid to be poured can be grasped more reliably.
(8) Although the hydraulic fluid is used as the operating liquid enclosed in the cylinder in the first to fourth embodiments, another liquid may be employed as long as it can generate a predetermined damping force.
(9) In the first to fourth embodiments, air is exemplified as a gas contained in the cylinder before the hydraulic fluid is enclosed. However, another gas may be used.

### EXPLANATION OF REFERENCE SYMBOLS

C . . . ceiling; F . . . furniture (article); W . . . wall surface; 1, 201, 301, 401 . . . overturn preventing device; 10 . . . damper; 11, 311 . . . cylinder; 11A, 12A . . . inlet; 11B . . . rod side pressure chamber; 11C . . . counter-rod side pressure chamber; 12 . . . rod guide; 13, 213 . . . rod; 14 . . . piston; 15 . . . damping part (15A . . . orifice, 15B . . . check valve); 16 . . . compression coil spring (biasing part); 17, 417 . . . screw cap; 18 . . . joint; 18A . . . through hole; 21, 22 . . . base (21 . . . first base, 22 . . . second base); 23 . . . base body; 23A . . . insertion hole; 24 . . . bolt; 24A . . . shaft part; 25 . . . nut; 26 . . . bush; 26A . . . concave portion; 26B . . . outer peripheral surface; 26C . . . inner peripheral surface; 213A . . . scale (mark); and 311A . . . window (a part of the cylinder formed to be transparent).

1. An overturn preventing device comprising:
a damper including a cylinder having an end with an opening, a piston slidably housed in the cylinder, a rod having a distal end side protruding out of the cylinder and a proximal end coupled to the piston and a rod guide into which the rod is slidably inserted, the rod guide closing the opening of the cylinder, the damper being configured to be mounted between a top surface of an article installed on an installation surface and a ceiling; and
a pair of bases respectively coupled to two ends of the damper, one of which bases is configured to abut against the top surface of the article and the other of which bases is configured to abut against the ceiling,
wherein the damper has an inlet through which an operating liquid is poured into the cylinder.

2. The overturn preventing device according to claim 1, wherein the damper has a biasing part imparting a biasing force which biases the rod in such a direction that the rod protrudes out of the cylinder.

3. The overturn preventing device according to claim 1, wherein the rod is formed with a mark indicative according to an amount of protrusion out of the cylinder.

4. The overturn preventing device according to claim 1, wherein the cylinder includes at least a part thereof formed to be transparent.

5. The overturn preventing device according to claim 1, wherein the inlet is formed at a location near the opening side end of the cylinder.

6. The overturn preventing device according to claim 1, wherein the inlet is formed in the rod guide.

7. A method of mounting the overturn preventing device as specified in claim 1, the method comprising:
a step of causing the paired bases to abut against the top surface of the article and the ceiling respectively; and
a step of pouring the operating liquid through the inlet into the cylinder.

8. The overturn preventing device according to claim 2, wherein the rod is formed with a mark indicative according to an amount of protrusion out of the cylinder.

9. The overturn preventing device according to claim 2, wherein the cylinder includes at least a part thereof formed to be transparent.

10. The overturn preventing device according to claim 2, wherein the inlet is formed at a location near the opening side end of the cylinder.

11. The overturn preventing device according to claim 2, wherein the inlet is formed in the rod guide.

12. A method of mounting the overturn preventing device as specified in claim 2, the method comprising:
a step of causing the paired bases to abut against the top surface of the article and the ceiling respectively; and
a step of pouring the operating liquid through the inlet into the cylinder.
